(19) United States
(12) Patent Application Publication
(10) Pub. No.: US 2019/0130603 A1
(43) Pub. Date: May 2, 2019

(54) DEEP-LEARNING BASED FEATURE MINING FOR 2.5D SENSING IMAGE SEARCH

(71) Applicant: Siemens Aktiengesellschaft, Munich (DE)

(72) Inventors: Shanhui Sun, Princeton, NJ (US); Kai Ma, West Windsor, NJ (US); Stefan Kluckner, Rum (AT); Ziyan Wu, Plainsboro, NJ (US); Jan Ernst, Plainsboro, NJ (US); Vivek Kumar Singh, Princeton, NJ (US); Terrence Chen, Princeton, NJ (US)

(21) Appl. No.: 16/082,920

(22) PCT Filed: Mar. 9, 2017
(86) PCT No.: PCT/US2017/021535

§ 371 Date: Sep. 6, 2018

Related U.S. Application Data
(60) Provisional application No. 62/307,001, filed on Mar. 11, 2016.

(51) Int. Cl. G06T 7/73; G06K 9/62; G06K 9/46

(52) U.S. Cl. CPC G06T 7/75; G06K 9/6276; G06K 9/4609; G06T 2207/20084; G06T 2207/10028; G06T 2207/20081; G06K 9/6256

(57) ABSTRACT

Systems, methods, and computer-readable media are disclosed for determining feature representations of 2.5D image data using deep learning techniques. The 2.5D image data may be synthetic image data generated from 3D simulated model data such as 3D CAD data. The 2.5D image data may be indicative of any number of pose estimations/camera poses representing virtual or actual viewing perspectives of an object modeled by the 3D CAD data. A neural network such as a convolution neural network (CNN) may be trained using the 2.5D image data as training data to obtain corresponding feature representations. The pose estimations/camera poses may be stored in a data repository in association with the corresponding feature representations. The learnt CNN may then be used to determine an input feature representation from an input 2.5D image and index the input feature representation against the data repository to determine matching pose estimation(s).

### CROSS-REFERENCE TO RELATED APPLICATION(S)

This application claims the benefit of U.S. Provisional Application No. 62/307,001 filed on Mar. 11, 2016, the content of which is incorporated herein in its entirety.

### BACKGROUND

A two and a half dimensional (2.5D) image may be an image representation on a single plane of a three-dimensional (3D) object placed at an angle to the plane of projection. As such, a 2.5D image may be thought of as a 2D graphical projection that simulates the appearance of being 3D. A 2.5D image includes both color information and depth information, whereas depth information is absent from a 2D image. Matching 2.5D images can be difficult compared to matching 2D images due to the absence of 2D features such as edge, texture, and content semantic from 2.5D images as well as missing data, noise, and background disturbances present in 2.5D images as a result of hardware limitations and sensing characteristics of depth sensors. Thus, traditionally developed image features associated with 2D images are not suitable for representing 2.5D image data.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral identifies the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a schematic diagram depicting mapping of 2.5D images indicative of pose estimations of 3D simulated model data to corresponding feature representations in accordance with one or more example embodiments of the disclosure.

FIG. 2 is schematic diagram depicting training of a convolution neural network (CNN) to determine and populate a data repository with feature representation and pose estimation pairings and utilization of the trained CNN and the populated data repository to determine a feature representation of an input 2.5D image and a corresponding matching pose estimation in accordance with one or more example embodiments of the disclosure.

FIG. 3 is a schematic diagram of a CNN in accordance with one or more example embodiments of the disclosure.

FIG. 4 is a process flow diagram of an illustrative method for training a CNN and utilizing a learnt CNN to determine a matching pose estimation for an 2.5D input image in accordance with one or more example embodiments of the disclosure.

FIG. 5 is a schematic diagram of an illustrative networked architecture in accordance with one or more example embodiments of the disclosure.

### DETAILED DESCRIPTION

### Overview

This disclosure relates to, among other things, devices, servers, systems, methods, computer-readable media, techniques, and methodologies for determining feature representations of 2.5D image data using deep learning techniques. The 2.5D image data may be synthetic image data generated from 3D simulated model data which may be, for example, 3D computer-aided design (CAD) data. The 3D CAD data may be represented in 3D space using XYZ coordinate systems and may be noise-free. Connections between vertices in the 3D CAD data may be identified using geometric primitives such as triangles or tetrahedrons or more complex 3D representations composing the 3D CAD model. In certain example embodiments, the 3D CAD data may be representative of a physical parts assembly.

In example embodiments of the disclosure, multiple different virtual viewpoints of the 3D simulated model data may be identified. The virtual viewpoints of the 3D simulated model data may be referred to herein as pose estimations and may each represent a unique view of the 3D simulated model data from the perspective of a virtual observer. Any number of pose estimations of the 3D simulated model data may be identified at any level of granularity. In those example embodiments in which the 3D simulated model data is representative of a parts assembly, it may be desirable to identify a sufficient number of pose estimations that represent virtual viewpoints of the 3D simulated model of the parts assembly from enough different angles and perspectives of a virtual observer so as to enable identification of any part within the assembly. In certain example embodiments, certain parts in an assembly may be occluded, and thus, may not be visible from certain potential viewpoints (or from any potential viewpoint). Accordingly, it may be necessary to identify enough pose estimations to capture those viewpoints from which an assembly part is visible, particularly when the assembly part is occluded from other viewpoints.

In certain example embodiments, during an offline training phase, the 3D CAD data may be used to generate 2.5D synthetic image data representative of different pose estimations that simulate viewpoints of an observer of an object represented by the 3D CAD data from different positions and orientations. A mapper may then map the set of pose estimations to corresponding feature representations such as feature vectors. Each pose estimation and its corresponding feature representation (referred to herein at times as a pose estimation and feature representation pairing) may be stored in association with one another in a data repository. Each feature representation may be, for example, a feature vector or other suitable data structure that is representative of a corresponding pose estimation. Each feature representation may indicate the extent to which each feature in a set of features is represented within the corresponding pose estimation. The set of features may be machine-learned by training the mapper. For example, machine learning techniques may be employed to identify those features that are the most discriminative in identifying any given pose estimation and differentiating it from each other pose estimation. Each feature representation may be unique to a particular pose estimation and may serve as a reduced-dimension representation of the pose estimation.

Subsequently, during an operational phase, the mapper may map an input 2.5D image to a corresponding input feature representation. The input 2.5D image may include depth information in addition to color, grayscale, or bi-tonal image data. In certain example embodiments, the 2.5D image may be an image of an object such as a physical parts assembly and may be captured by a mobile device that is configured to capture depth information using one or more depth sensing technologies (e.g., light detection and ranging (LIDAR)). The input feature representation may then be indexed against the data repository to identify one or more matching pose estimations. More specifically, a K-nearest neighbor search of the data repository may be performed based on the input feature representation to retrieve one or more stored feature representations that satisfy the search parameters. The K-nearest neighbor search may be based on the Fast Library for Approximate Nearest Neighbors (FLANN), which is a library for performing fast approximate nearest neighbor searches in high dimensional spaces. The corresponding one or more pose estimations stored in association with the retrieved feature representation(s) may be considered pose estimation(s) that match the actual pose in the input 2.5D image data. The actual pose represented in an input image may be referred to herein as a camera pose. The term camera pose may also be used interchangeably with the term pose estimation at times herein.

After identifying a matching pose estimation, in certain example embodiments, a 2D label map may be rendered from the 3D simulated model data based on the matching pose estimation. The label map may be rendered as an overlay on the input image. In this manner, if, for example, the 3D simulated model data is 3D CAD data of a parts assembly, the label map may serve to identify parts of the assembly that appear in the input image. In certain example embodiments, a user may be provided with the capability to select a region of interest (ROI) in the input image. The matching pose estimation, or more specifically the rendering of the 3D CAD data based on the matching pose estimation, may then be used to identify one or more parts present in the selected ROI.

In certain example embodiments, the mapper may be a machine-learned model. The learning method may be an unsupervised learning approach such as an auto-encoder based method. In example embodiments, a deep CNN may be used to learn the feature representations. In such example embodiments, the mapper may be a CNN network learner such as, for example, a stochastic gradient descent optimizer. The learnt CNN model may then be used during the operational phase to determine an input feature representation corresponding to an input image. In certain alternative example embodiments, the mapping between an input image and a corresponding camera pose (e.g., viewpoint) of the input image may be directly trained in lieu of building a data repository of pose estimation and feature representation pairings, in which case, the mapper may be a camera pose classifier or regressor. However, in certain example embodiments, it may be advantageous to learn the set of feature representations and build the data repository as described above instead of directly learning the mapping due to the difficulty of handling a large camera pose space in classification or regression frameworks.

### Illustrative Embodiments

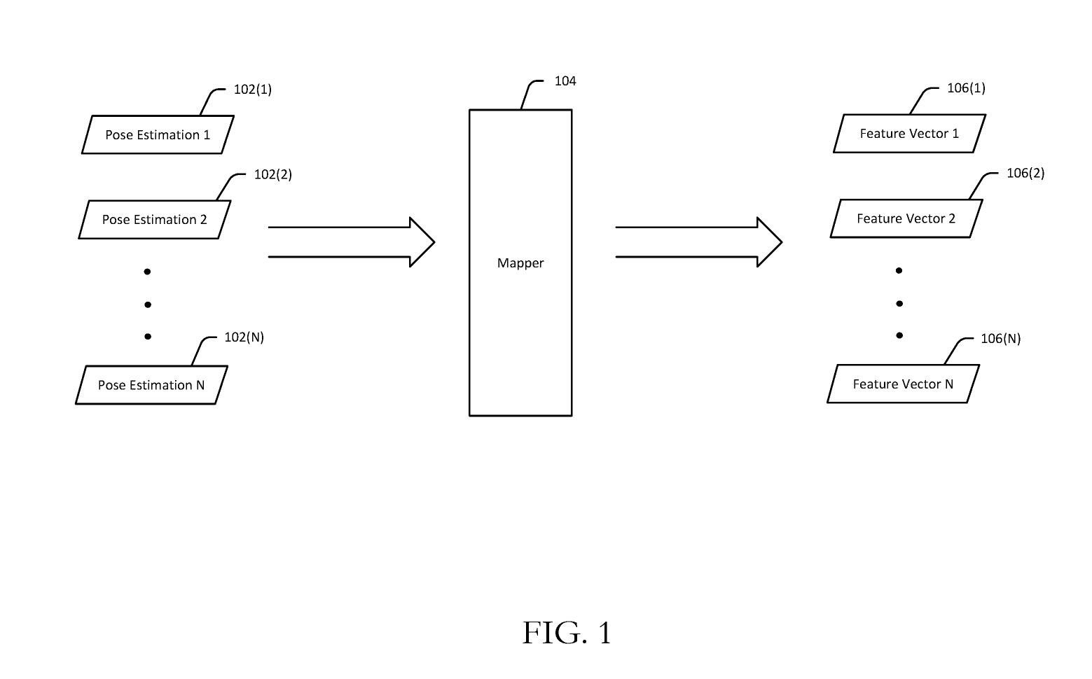

FIG. 1 is a schematic diagram depicting mapping of 2.5D images indicative of pose estimations of 3D simulated model data to corresponding feature representations. A set of pose estimations 102(1)-102(N) may be identified and provided as input to a mapper 104. N may be any integer greater than or equal to one. The mapper may be configured to determine a set of feature representations (e.g., feature vectors 106(1)-106(N)) from the set of pose estimations 102(1)-102(N).

In certain example embodiments, the mapper 104 may utilize a predetermined set of features to represent a 2.5D image. For example, dense or sparse SIFT may be used with a set of feature words (e.g., ensemble SIFT features to a lower dimensional space) to represent a 2.5D image (e.g., synthetic 2.5D image data corresponding to a pose estimation). However, while such methods work well on 2D RGB images, gradient-based descriptors may not be able to fully utilize depth information. In one or more other example embodiments, a 3D point cloud may be reconstructed from a depth image to derive a representation from the point cloud such as a point feature histogram. However, such representations may not be robust to noise and background disturbances and may be sensitive to view point change.

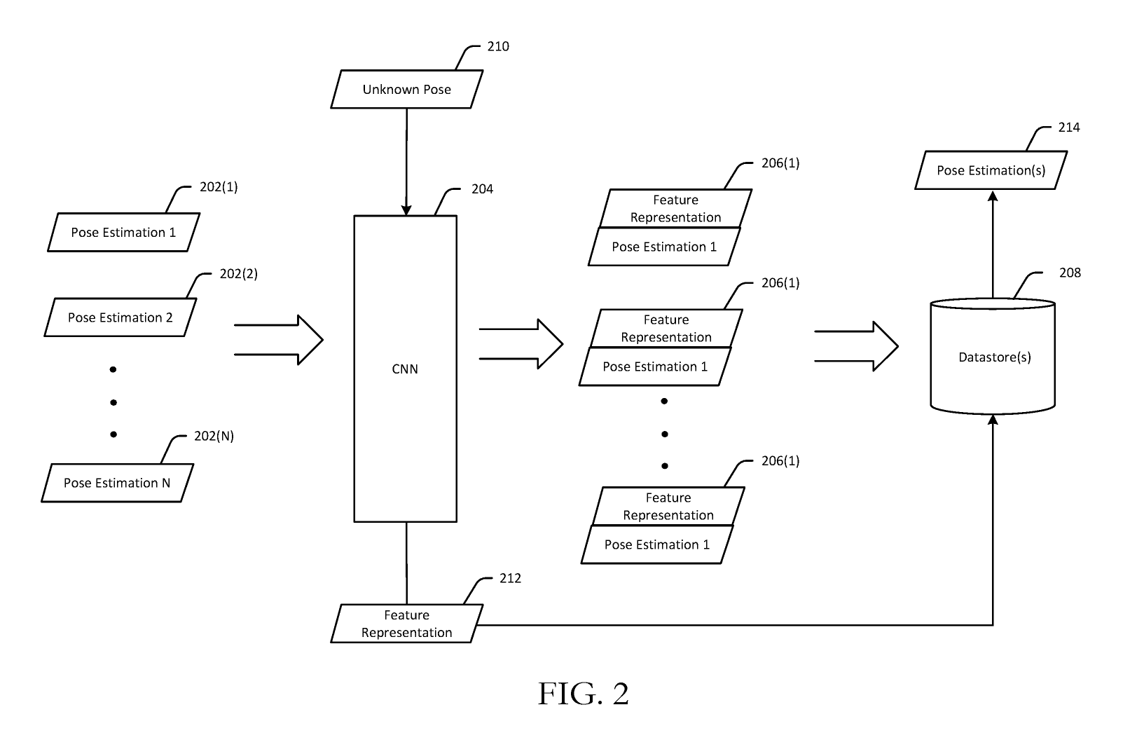

In certain example embodiments, the mapper 104 may be a machine-learned model such as a CNN, which will be described in more detail later in this disclosure in reference to FIGS. 2-4. In certain other example embodiments, the mapper 104 may be directly trained to map an input image and a corresponding camera pose in lieu of building a data repository of pose estimation and feature representation pairings, in which case, the mapper 104 may be a classifier in a discrete space mapping or a regressor in a continuous space mapping.

In certain example embodiments, the set of pose estimations 102(1)-102(N) may be obtained from actual camera poses (e.g., sample poses captured as input 2.5D image data). Based on these prior camera poses, new poses can be augmented. However, in other example embodiments, such as those in which automated identification of parts of a parts assembly is desired, such a sampling method involving capturing actual camera poses may not be able to cover the entire view space. Accordingly, in such example embodiments, the set of pose estimations 102(1)-102(N) may be randomly generated as synthetic 2.5D image data from 3D simulated model data (e.g., 3D CAD data) within the 3D sensor allowed range. Further, in such example embodiments, while depth image data may be generated with respect to all camera poses within the 3D sensor allowed range, only those representing camera poses in which at least some portion of an object represented by the 3D CAD data is visible may be provided as input to the mapper 104.

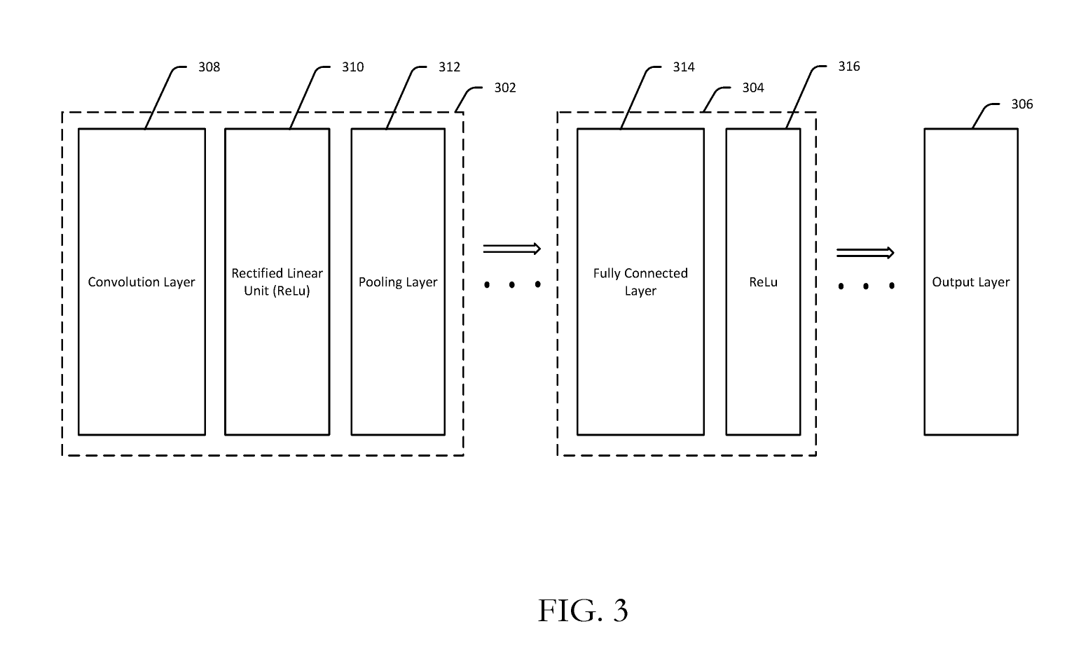

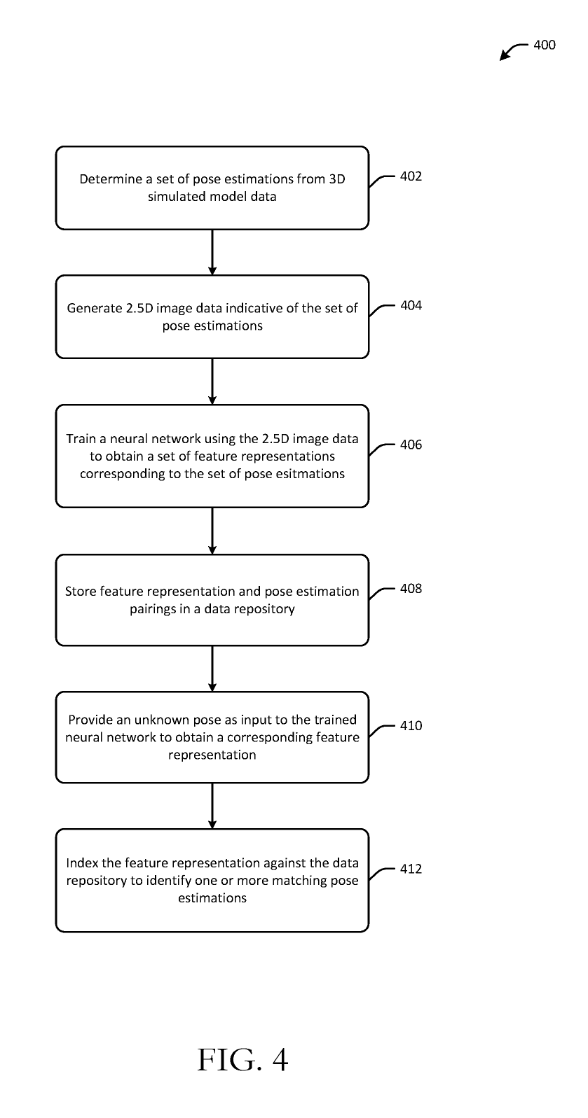

FIG. 2 is schematic diagram depicting training of a convolution neural network (CNN) to determine and populate a data repository with feature representation and pose estimation pairings and utilization of the trained CNN and the populated data repository to determine a feature representation of an input 2.5D image and a corresponding matching pose estimation. FIG. 3 is a schematic diagram of an example CNN. FIG. 4 is a process flow diagram of an illustrative method 500 for training a CNN and utilizing a learnt CNN to determine a matching pose estimation for an 2.5D input image. FIGS. 2-4 will be described in conjunction with one another hereinafter.

Each operation of any of the method 400 may be performed by one or more components that may be implemented in any combination of hardware, software, and/or firmware. In certain example embodiments, one or more of these component(s) may be implemented, at least in part, as software and/or firmware that contains or is a collection of one or more program modules that include computer-executable instructions that when executed by a processing circuit cause one or more operations to be performed. A system or device described herein as being configured to implement example embodiments of the invention may include one or more processing circuits, each of which may include one or more processing units or nodes. Computer-executable instructions may include computer-executable program code that when executed by a processing unit may cause input data contained in or referenced by the computer-executable program code to be accessed and processed to yield output data.

Referring first to FIG. 2 in conjunction with FIG. 4, at block 402 of the method 400, computer-executable instructions of one or more training modules may be executed to determine a set of pose estimations 202(1)-202(N) from 3D simulated model data (e.g., 3D CAD data). As similarly noted with respect to FIG. 1, the set of pose estimations 202(1)-202(N) may be obtained from actual camera poses (e.g., sample poses captured as input 2.5D image data). Alternatively, at block 404 of the method 400, computer-executable instructions of the training module(s) may be executed to generate synthetic 2.5D image data indicative of the set of pose estimations 202(1)-202(N) from the 3D simulated model data within the 3D sensor allowed range. At block 406 of the method 400, computer-executable instructions of the training module(s) may be executed to train a neural network using the 2.5D image data indicative of the set of pose estimations 202(1)-202(N) to obtain a set of corresponding feature representations. In certain example embodiments, the neural network may be a CNN 204 as shown in FIG. 2.

An example architecture of the CNN 204 is depicted in FIG. 3. According to the example architecture, the CNN 204 may include one or more convolution layer units 302, followed by one or more fully connected layer units 316, which in turn are followed by an output layer 306. Each convolution layer unit 302 may include a convolution layer 308, a rectified linear unit (ReLu) 310, and a pooling layer 312. The ReLu 310 may receive the output of the convolution layer 308 as input, and the pooling layer 312 may receive the output of the ReLu 310 as input. Each fully connected layer unit 304 may include a fully connected layer 314 followed by a ReLu 316. The layers of each convolution layer unit 302 and the layers of each fully connected layer unit 304 may together constitute hidden layers of the CNN 204. While any number of convolution layer units 302 and any number of fully connected layer units 304 may be provided, in certain example embodiments, 2 convolution layer units 302 and 2 fully connected layer units 304 may be provided. That is, two convolution layers 308 may be provided, each of which is followed by a ReLu 310 and a pooling layer 312, and two fully connected layers 314 may be provided, each of which is followed by a ReLu 316. The output layer 306 may be a group of nodes that are fully connected to the previous layer in the CNN 204

In certain example embodiments, the set of feature representations may be learned from the 2.5D image data indicative of the set of pose estimations 202(1)-202(N) using an auxiliary classification layer (not shown) provided immediately after the output layer 306. The set of feature representations may then be obtain from classification training. In certain example embodiments, the training data (e.g., the 2.5D image data) may be evaluated to categorize the set of pose estimations 202(1)-202(N) in X categories. In order to ensure that meaningful categories are formed, a 2D label map may be rendered from the 3D simulated model data for each pose estimation. The degree of similarity between two pose estimations may be determined based on the overlapping ratio of their corresponding 2D label maps, and this degree of similarity may be used to define categories. A stochastic gradient descent function may be used as an optimizer for training and a cross entropy error function may be used as a loss function.

In other example embodiments, the set of feature representations may be directly learned from the 2.5D image data without the use of an auxiliary classification layer. Such an approach avoids class labelling and learns feature representations from the 2.5D image data using, for example, triplet and pairwise sampling for image matching. In contrast to the approach that utilizes an auxiliary classification layer and thus classification loss to learn feature representations, this approach may train descriptors natively to lie on a pseudo-metric manifold. This may enable use of off-the-shelf matching algorithms that have already been optimized for such metric spaces such as Euclidean spaces.

In those example embodiments in which the feature representations are learned without the use of an auxiliary classification layer, the underlying basis for the approach may be the assumption that Euclidean distances between feature representations corresponding to similar pose estimations are expected to be small while Euclidean distances between feature representations corresponding to non-similar pose estimations are expected to be large. To enforce this requirement, the following loss function over all weights of the CNN 204 may be used:

L=Lₜᵣᵢₚₗₑₜ+L_{pairwise}+λ|w|₂² (Eq. 1)

where Lₜᵣᵢₚₗₑₜ is a triplet loss function and L_{pairwise} is a pairwise loss function. The last term in Eq. 1 is regularization term for minimizing overfitting.

A triplet may be defined as (pᵢ, pᵢ_{_}ₚₒₛᵢₜᵢᵥₑ, pᵢ_{_}_{negative}), where pᵢ is one pose estimation/camera pose sampling point, pᵢ_{_}ₚₒₛᵢₜᵢᵥₑ is a pose estimation/camera pose that is similar to pᵢ, and pᵢ_{_}_{negative} is a pose estimation/camera pose that is non-similar to pᵢ. The triplet loss function Lₜᵣᵢₚₗₑₜ may be defined in various ways. According to certain example embodiments, Lₜᵣᵢₚₗₑₜ may be defined as follows:

Lₜᵣᵢₚₗₑₜ=Σ_{(pi,pi}_{_}_{positive,pi}_{_}_{negative)}max(0,1−(|f(pᵢ)−f(pᵢ_{_}_{negative})|₂)/(|f(pᵢ)−(f(pᵢ_{_}ₚₒₛᵢₜᵢᵥₑ)|₂+m)) (Eq. 2)

where f( ) is the feature representation corresponding to a particular pose estimation/camera pose. According to certain other example embodiments, Lₜᵣᵢₚₗₑₜ may instead be defined as follows:

LₜᵣᵢₚₗₑₜΣ_{(pi,pi}_{_}_{positive,pi}_{_}_{negative)}max(0,m+|f(pᵢ)−f(pᵢ_{_}ₚₒₛᵢₜᵢᵥₑ)|₂²−|f(pᵢ)−f(pᵢ_{_}_{negative})|₂² (Eq. 3).

The discriminative nature of a feature representation (its ability to uniquely identify a pose estimation/camera pose and distinguish it from other pose estimation/camera poses) may depend on the triplets that are selected for the CNN 204. In certain example embodiments, in order to determine positive and negative samples (e.g., pᵢ_{_}ₚₒₛᵢₜᵢᵥₑ and pᵢ_{_}_{negative} for a given pᵢ), a 2D label map may be rendered from the 3D CAD data for each pose estimation/camera pose. The degree of similarity or dissimilarity between two pose estimations/camera poses (whether a pose estimation/camera pose is a negative or positive sample with respect to a given pose estimation/camera pose) may then be determined based on the degree of overlap between their corresponding 2D label maps.

In other example embodiments, the criterion defined in the following formula may be considered to identify positive and negative samples: |T₁−T₂|₂<Threshold_{T} and |R₁−R₂|_{q2}<Threshold_{R} (Formula 1), where T is the 3D camera position, R is the 3D camera rotation matrix, | . . . |₂ is a L2 norm, and | . . . |_{q2} is an operation of finding angle distance between two rotation matrices. Two samples (e.g., two pose estimations/camera poses) may be treated as close (positive) if the criterion of Formula 1 is met, while two samples may be treated as not being close (negative) if the criterion of Formula 1 is not met. In certain example embodiments, the rotation matrix may be converted to quaternion coordinate and an angle distance may be determined between two quaternion coordinates. For the triplet data, in certain example embodiments, ideal synthetic depth data that does not contain noise may be used (e.g., synthetic 2.5D image data generated from 3D simulated model data). In other example embodiments, a structured noise pattern may be simulated over the ideal synthetic data, and the synthetic data with the simulated noise pattern may be used as the training data.

Referring again to Eq. 1, L_{pairwise} may be a Euclidean loss function. A pairwise tuple may be defined as (pᵢ, pᵢ_{_}_{disturbance}), where pᵢ is one pose estimation/camera pose sampling point and pᵢ_{_}_{disturbance} is pᵢ's perturbations in terms of pose, noise condition, and background. The L_{pairwise} term may ensure that similar pose estimations/camera poses with different backgrounds and noise will nonetheless result in similar feature representations. In certain example embodiments, pᵢ may be ideal depth image data and pᵢ_{_}_{disturbance} may be a random perturbation of pi with structured noise. In certain example embodiments, in order to learn a robust representation of the background in depth image data, Perlin noise may be randomly added to the depth image background. The background in depth image data may be identified as non-zero pixels in noise-free data. Further, in certain example embodiments, white noise may be added to foreground pixels.

Once the CNN 204 is trained, the set of feature representations obtained from the depth image data representative of the set of pose estimations/camera poses 202(1)-202(N) may be stored in one or more datastores 208 at block 408 of the method 400. In particular, the set of pose estimations 202(1)-202(N), or more specifically the 2.5D image data indicative of the set of pose estimations 202(1)-202(N), may be stored in the datastore(s) 208 in association with the corresponding feature representations as pose estimation and feature representation pairings 206(1)-206(N). 2.5D image data with structured noise added thereto or ideal synthetic 2.5D image data may be used to populate the datastore(s) 208.

At block 410 of the method 400, computer-executable instructions of one or more pose estimation determination modules may be executed to provide an unknown camera pose 210 to the trained CNN 204 as input in order to obtain a corresponding input feature representation 212. Then, at block 412 of the method 400, the input feature representation 212 may be indexed against the datastore(s) 208 to identify one or more matching pose estimations 214. More specifically, a FLANN based K-nearest neighbor search of the datastore(s) 208 may be performed based on the input feature representation 212 to retrieve one or more stored feature representations that satisfy the search parameters. In particular, an L2 norm may be used to compare the input feature representation 212 with each stored feature representation in the datastore(s) 208. An L2 norm may be used during search because an L2 norm is enforced in both the triplet loss function and the pairwise loss function. The corresponding one or more pose estimations 214 stored in association with the retrieved feature representation(s) may be considered pose estimation(s) that match the actual pose in the input 2.5D image data 210. K candidate matching pose estimations(s) 214 may be selected in order to reduce the false negative rate, which may provide a robust automated part identification in certain example embodiments.

In certain example embodiments, in lieu of using a FLANN based K-nearest neighbor search, a hash table can be learned for retrieving the matching pose estimation(s) 214. In particular, a respective binary code may be assigned to each pose estimation/camera pose 202(1)-202(N), and another neural network fully connected immediately after the CNN 204 having, for example, the example architecture depicted in FIG. 3 may be trained. The network parameters for the CNN 204 may be fixed, while the network weights of the additional neural network fully connected to the CNN 204 may be trained. The approach described with respect to Formula 1 may be used to train the network weights of the additional neural network.

Example embodiments of the disclosure include or yield various technical features, technical effects, and/or improvements to technology. For instance, example embodiments of the disclosure yield the technical effect of producing more robust and efficient image searching for 2.5D images. This technical effect is achieved, at least in part, by the technical feature of utilizing deep machine learning techniques to determine feature representations directly from 3D simulated model data in a manner that is robust to sensor limitations. More specifically, ideal synthetic noise-free 2.5D image data (or 2.5D image data with structured noise added thereto) may be generated from 3D simulated model data to obtain a training dataset that may then be used to train a mapper such as a neural network to obtain a corresponding feature representation for each pose estimation/camera pose embodied in the 2.5D image data. The technical effect of more robust and efficient image searching for 2.5D images is further achieved, at least in part, by building a data repository of pose estimation/camera pose and feature representation pairings that can be searched using an input feature representation obtained from an input 2.5D image in order to identify matching pose estimation(s). By learning feature representations directly from 3D simulated model data (e.g., 3D CAD data, more robust feature representations are obtained, thereby reducing false recognition/detection rates. By virtue of at least the improved image recognition (e.g., reduced false recognition/detection rates), example embodiments of the disclosure yield an improvement to the functioning of a computer, specifically, the functioning of computers configured to execute image recognition algorithms.

In addition, example embodiments of the disclosure learn feature representations (e.g., a descriptor space) that are implicitly optimized for large scale image searches such as binary hash functions, thereby representing an improvement over existing approaches that must learn such representations in 2 steps—a first step in which a descriptor space is learned and a second step in which a compressor or hash function is learned. Further, example embodiments in which the feature representations are learned without class labeling yield the technical effect of enabling usage of off-the-shelf matching algorithms that have already been optimized for certain metric spaces such as Euclidean spaces. It should be appreciated that the above examples of technical features, technical effects, and improvements to computer technology/the functioning of a computer provided by example embodiments of the disclosure are merely illustrative and not exhaustive.

One or more illustrative embodiments of the disclosure have been described above. The above-described embodiments are merely illustrative of the scope of this disclosure and are not intended to be limiting in any way. Accordingly, variations, modifications, and equivalents of embodiments disclosed herein are also within the scope of this disclosure. The above-described embodiments and additional and/or alternative embodiments of the disclosure will be described in detail hereinafter through reference to the accompanying drawings.

### Illustrative Networked Architecture

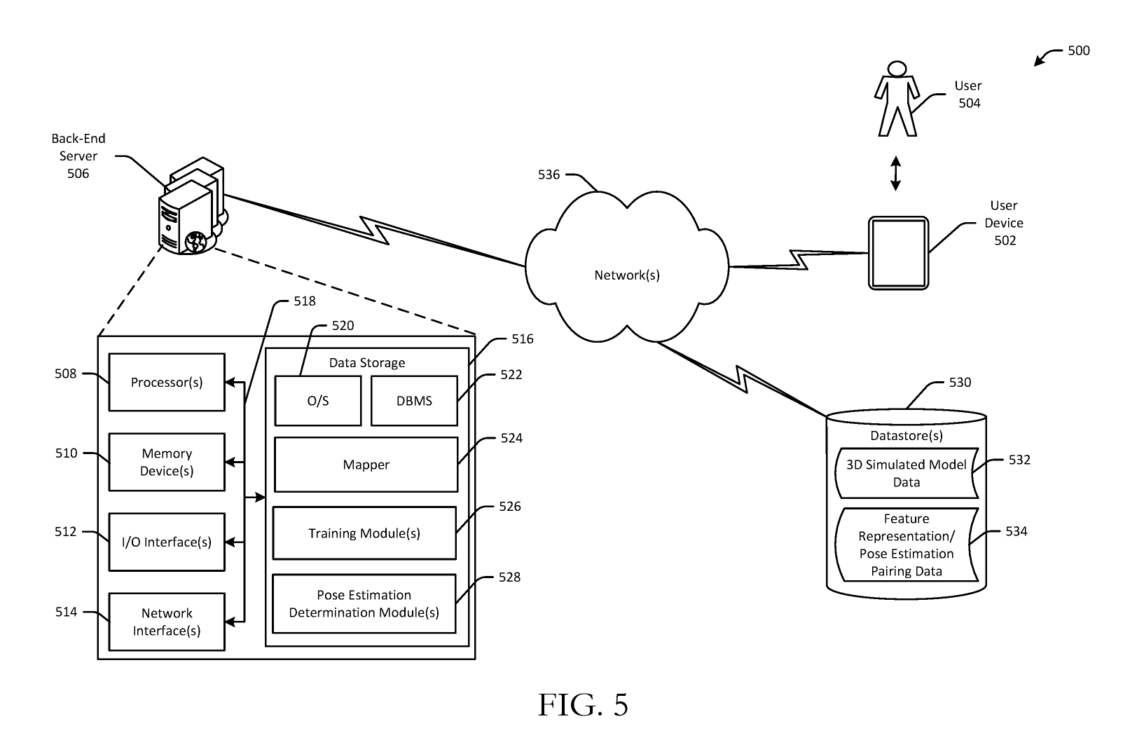

FIG. 5 is a schematic diagram of an illustrative networked architecture 500 in accordance with one or more example embodiments of the disclosure. The networked architecture 500 may include one or more user devices 502, each of which may be utilized by a corresponding user 504. The networked architecture 500 may further include one or more back-end servers 506 and one or more datastores 530. The user device(s) 502 may be configured to capture 2.5D image data that may be provided as input to the server 506. While multiple user devices 502 and/or multiple back-end servers 506 may form part of the networked architecture 500, these components will be described in the singular hereinafter for ease of explanation. However, it should be appreciated that any functionality described in connection with the back-end server 506 may be distributed among multiple back-end servers 506. Similarly, any functionality described in connection with the user device 502 may be distributed among multiple user devices 502 and/or between a user device 502 and one or more back-end servers 506.

The user device 502 and the back-end server 506 may be configured to communicate via one or more networks 536 which may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, the network(s) 536 may have any suitable communication range associated therewith and may include, for example, global networks (e.g., the Internet), metropolitan area networks (MANS), wide area networks (WANs), local area networks (LANs), or personal area networks (PANs). In addition, the network(s) 536 may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the back-end server 506 may include one or more processors (processor(s)) 508, one or more memory devices 510 (generically referred to herein as memory 510), one or more input/output (“I/O”) interface(s) 512, one or more network interfaces 514, and data storage 516. The back-end server 506 may further include one or more buses 518 that functionally couple various components of the server 506. These various components will be described in more detail hereinafter.

The bus(es) 518 may include at least one of a system bus, a memory bus, an address bus, or a message bus, and may permit exchange of information (e.g., data (including computer-executable code), signaling, etc.) between various components of the server 506. The bus(es) 518 may include, without limitation, a memory bus or a memory controller, a peripheral bus, an accelerated graphics port, and so forth. The bus(es) 518 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 510 of the server 506 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 510 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 510 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 516 may include removable storage and/or non-removable storage including, but not limited to, magnetic storage, optical disk storage, and/or tape storage. The data storage 516 may provide non-volatile storage of computer-executable instructions and other data. The memory 510 and the data storage 516, removable and/or non-removable, are examples of computer-readable storage media (CRSM) as that term is used herein.

The data storage 516 may store computer-executable code, instructions, or the like that may be loadable into the memory 510 and executable by the processor(s) 508 to cause the processor(s) 508 to perform or initiate various operations. The data storage 516 may additionally store data that may be copied to memory 510 for use by the processor(s) 508 during the execution of the computer-executable instructions. Moreover, output data generated as a result of execution of the computer-executable instructions by the processor(s) 508 may be stored initially in memory 510, and may ultimately be copied to data storage 516 for non-volatile storage.

More specifically, the data storage 516 may store one or more operating systems (O/S) 520; one or more database management systems (DBMS) 522; and one or more program modules, applications, engines, algorithms, computer-executable code, scripts, or the like such as, for example, a mapper 524, one or more training modules 526, and one or more pose estimation determination modules 528. Any of the components depicted as being stored in data storage 516 may include any combination of software, firmware, and/or hardware. The software and/or firmware may include computer-executable code, instructions, or the like that may be loaded into the memory 510 for execution by one or more of the processor(s) 508 to perform any of the operations described earlier in connection with correspondingly named modules.

The data storage 516 may further store various types of data utilized by components of the server 506 such as, for example, any of the data depicted as being stored in the datastore(s) 530. Any data stored in the data storage 516 may be loaded into the memory 510 for use by the processor(s) 508 in executing computer-executable code. In addition, any data stored in the datastore(s) 530 may be accessed via the DBMS 522 and loaded in the memory 510 for use by the processor(s) 508 in executing computer-executable code.

The processor(s) 508 may be configured to access the memory 510 and execute computer-executable instructions loaded therein. For example, the processor(s) 508 may be configured to execute computer-executable instructions of the various program modules, applications, engines, or the like of the server 506 to cause or facilitate various operations to be performed in accordance with one or more embodiments of the disclosure. The processor(s) 508 may include any suitable processing unit capable of accepting data as input, processing the input data in accordance with stored computer-executable instructions, and generating output data. The processor(s) 508 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 508 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 508 may be capable of supporting any of a variety of instruction sets.

Referring now to other illustrative components depicted as being stored in the data storage 516, the O/S 520 may be loaded from the data storage 516 into the memory 510 and may provide an interface between other application software executing on the server 506 and hardware resources of the server 506. More specifically, the O/S 520 may include a set of computer-executable instructions for managing hardware resources of the server 506 and for providing common services to other application programs (e.g., managing memory allocation among various application programs). In certain example embodiments, the O/S 520 may control execution of one or more of the program modules depicted as being stored in the data storage 516. The O/S 520 may include any operating system now known or which may be developed in the future including, but not limited to, any server operating system, any mainframe operating system, or any other proprietary or non-proprietary operating system.

The DBMS 522 may be loaded into the memory 510 and may support functionality for accessing, retrieving, storing, and/or manipulating data stored in the memory 510 and/or data stored in the data storage 516. The DBMS 522 may use any of a variety of database models (e.g., relational model, object model, etc.) and may support any of a variety of query languages. The DBMS 522 may access data represented in one or more data schemas and stored in any suitable data repository.

The datastore(s) 530 (which may include the datastore(s) 208) may include, but are not limited to, databases (e.g., relational, object-oriented, etc.), file systems, flat files, distributed datastores in which data is stored on more than one node of a computer network, peer-to-peer network datastores, or the like. The datastore(s) 530 may store various types of data such as, for example, 3D simulated model data 532 (e.g., 3D CAD data), feature representation and pose estimation/camera pose pairing data 534, and so forth.

Referring now to other illustrative components of the server 506, the input/output (I/O) interface(s) 512 may facilitate the receipt of input information by the server 506 from one or more I/O devices as well as the output of information from the server 506 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the server 506 or may be separate. The I/O devices may further include, for example, any number of peripheral devices such as data storage devices, printing devices, and so forth.

The I/O interface(s) 512 may also include an interface for an external peripheral device connection such as universal serial bus (USB), FireWire, Thunderbolt, Ethernet port or other connection protocol that may connect to one or more networks. The I/O interface(s) 512 may also include a connection to one or more antennas to connect to one or more networks via a wireless local area network (WLAN) (such as Wi-Fi) radio, Bluetooth, and/or a wireless network radio, such as a radio capable of communication with a wireless communication network such as a Long Term Evolution (LTE) network, WiMAX network, 3G network, etc.

The server 506 may further include one or more network interfaces 514 via which the server 506 may communicate with any of a variety of other systems, platforms, networks, devices, and so forth. The network interface(s) 514 may enable communication, for example, with the user device 502 and/or the datastore(s) 556 via the network(s) 514.

Referring now to the user device 502, in certain example embodiments, the user device 502 may execute a camera application that enables capturing 2.5D image data. The user device 502 may further execute an application that enables a user 504 of the user device 502 to capture an image of a parts assembly and initiate automated identification of parts of the assembly using, for example, a learned CNN as described herein.

In an illustrative configuration, the user device 502 may include any of the types of bus(es) or bus architectures described in reference to the bus(es) 518; any of the types of processors described in reference to the processor(s) 508; any of the types of memory described in reference to the memory 510; any of the types of data storage described in reference to the data storage 516; any of the types of I/O interfaces described in reference to the I/O interface(s) 512; any of the types of network interfaces described in reference to the network interface(s) 514; any of the types of operating systems described in reference to the O/S 520; and any of the types of database management systems described in reference to the DBMS 522. The user device 502 may further include any of the components depicted and described as being stored in the data storage 516. Further, the user device 502 may include any number of sensors such as, for example, inertial sensors, force sensors, thermal sensors, optical sensors, time-of-flight sensors, 3D depth sensors, and so forth. Example types of inertial sensors may include accelerometers (e.g., MEMS-based accelerometers), gyroscopes, and so forth.

In addition, the user device 502 may further include one or more antennas such as, for example, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. The antenna(s) may include any suitable type of antenna depending, for example, on the communications protocols used to transmit or receive signals via the antenna(s). Non-limiting examples of suitable antennas may include directional antennas, non-directional antennas, dipole antennas, folded dipole antennas, patch antennas, multiple-input multiple-output (MIMO) antennas, or the like. The antenna(s) may be communicatively coupled to one or more radio components to which or from which signals may be transmitted or received.

The radio(s) may include any suitable radio component(s) for—in cooperation with the antenna(s)—transmitting or receiving radio frequency (RF) signals in the bandwidth and/or channels corresponding to the communications protocols utilized by the user device 502 to communicate with other devices. The radio(s) may include hardware, software, and/or firmware for modulating, transmitting, or receiving—potentially in cooperation with any of antenna(s)—communications signals according to any of the communications protocols discussed above including, but not limited to, one or more Bluetooth communication protocols, one or more Wi-Fi and/or Wi-Fi direct protocols, as standardized by the IEEE 802.11 standards, one or more non-Wi-Fi protocols, or one or more cellular communications protocols or standards. The radio(s) may further include hardware, firmware, or software for receiving GNSS signals. The radio(s) may include any known receiver and baseband suitable for communicating via the communications protocols utilized by the user device 502. The radio(s) may further include a low noise amplifier (LNA), additional signal amplifiers, an analog-to-digital (A/D) converter, one or more buffers, a digital baseband, or the like.

It should be appreciated that the program modules, applications, computer-executable instructions, code, or the like depicted in FIG. 5 as being stored in the data storage 516 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the server 506, the user device 502, and/or hosted on other computing device(s) accessible via one or more of the network(s) 536, may be provided to support functionality provided by the program modules, applications, or computer-executable code depicted in FIG. 5 and/or additional or alternate functionality. Further, functionality may be modularized differently such that processing described as being supported collectively by the collection of program modules depicted in FIG. 5 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 5 may be implemented, at least partially, in hardware and/or firmware across any number of devices.

It should further be appreciated that the server 506 and/or the user device 502 may include alternate and/or additional hardware, software, or firmware components beyond those described or depicted without departing from the scope of the disclosure. More particularly, it should be appreciated that software, firmware, or hardware components depicted as forming part of the server 506 are merely illustrative and that some components may not be present or additional components may be provided in various embodiments. While various illustrative program modules have been depicted and described as software modules stored in data storage 516, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

One or more operations of the method 400 may be performed by a server 506, by a user device 502, or in a distributed fashion by a server 506 and a user device 502 having the illustrative configuration depicted in FIG. 5, or more specifically, by one or more engines, program modules, applications, or the like executable on such device(s). It should be appreciated, however, that such operations may be implemented in connection with numerous other device configurations.

The operations described and depicted in the illustrative method of FIG. 4 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIG. 4 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method, comprising:
determining a set of pose estimations from three-dimensional (3D) simulated model data;
generating image data indicative of the set of pose estimations, the image data comprising depth information;
mapping the image data indicative of the set of pose estimations to a set of feature representations;
storing, in a data repository, each pose estimation in the set of pose estimations in association with a respective corresponding feature representation in the set of feature representations;
mapping an input image to an input feature representation; and
indexing the input feature representation against the data repository to identify one or more matching pose estimations.

2. The computer-implemented method of claim 1, wherein mapping the image data indicative of the set of pose estimations to the set of feature representations comprises training a neural network using the image data.

3. The computer-implemented method of claim 2, wherein the neural network is a convolution neural network (CNN), and wherein mapping the image data indicative of the set of pose estimations to the set of feature representations comprises training the CNN using a stochastic gradient descent optimizer.

4. The computer-implemented method of claim 2, wherein mapping the input image to the input feature representation comprises providing the input image as input to the trained neural network to obtain the input feature representation.

5. The computer-implemented method of claim 1, wherein indexing the input feature representation again the data repository comprises performing a K-nearest neighbor search of the data repository using the input feature representation.

6. The computer-implemented method of claim 1, wherein the 3D simulated model data image data is 3D CAD data, and wherein the image data is 2.5D synthetic image data generated from the 3D CAD data.

7. The computer-implemented method of claim 1, wherein indexing the input feature representation again the data repository to identify the one or more matching pose estimations comprises:
identifying one or more feature representations stored in the data repository that match the input feature representation within a specified tolerance; and
determining that the one or more matching pose estimations are stored in associated with the one or more feature representations.

8. A system, comprising:
at least one memory storing computer-executable instructions; and
at least one processor configured to access the at least one memory and execute the computer-executable instructions to:
determine a set of pose estimations from three-dimensional (3D) simulated model data;
generate image data indicative of the set of pose estimations, the image data comprising depth information;
map the image data indicative of the set of pose estimations to a set of feature representations;
store, in a data repository, each pose estimation in the set of pose estimations in association with a respective corresponding feature representation in the set of feature representations;
map an input image to an input feature representation; and
index the input feature representation against the data repository to identify one or more matching pose estimations.

9. The system of claim 8, wherein the at least one processor is configured to map the image data indicative of the set of pose estimations to the set of feature representations by executing the computer-executable instructions to train a neural network using the image data.

10. The system of claim 9, wherein the neural network is a convolution neural network (CNN), and wherein the at least one processor is configured to map the image data indicative of the set of pose estimations to the set of feature representations by executing the computer-executable instructions to train the CNN using a stochastic gradient descent optimizer.

11. The system of claim 9, wherein the at least one processor is configured to map the input image to the input feature representation by executing the computer-executable instructions to provide the input image as input to the trained neural network to obtain the input feature representation.

12. The system of claim 8, wherein the at least one processor is configured to index the input feature representation again the data repository by executing the computer-executable instructions to perform a K-nearest neighbor search of the data repository using the input feature representation.

13. The system of claim 8, wherein the 3D simulated model data image data is 3D CAD data, and wherein the image data is 2.5D synthetic image data generated from the 3D CAD data.

14. The system of claim 8, wherein the at least one processor is configured to index the input feature representation again the data repository to identify the one or more matching pose estimations by executing the computer-executable instructions to:
identify one or more feature representations stored in the data repository that match the input feature representation within a specified tolerance; and
determine that the one or more matching pose estimations are stored in associated with the one or more feature representations.

15. A computer program product comprising a storage medium readable by a processing circuit, the storage medium storing instructions executable by the processing circuit to cause the processing circuit to perform the steps of:
determining a set of pose estimations from three-dimensional (3D) simulated model data;
generating image data indicative of the set of pose estimations, the image data comprising depth information;
mapping the image data indicative of the set of pose estimations to a set of feature representations;
storing, in a data repository, each pose estimation in the set of pose estimations in association with a respective corresponding feature representation in the set of feature representations;
mapping an input image to an input feature representation; and
indexing the input feature representation against the data repository to identify one or more matching pose estimations.

16. The computer program product of claim 15, wherein mapping the image data indicative of the set of pose estimations to the set of feature representations comprises training a neural network using the image data.

17. The computer program product of claim 16, wherein the neural network is a convolution neural network (CNN), and wherein mapping the image data indicative of the set of pose estimations to the set of feature representations comprises training the CNN using a stochastic gradient descent optimizer.

18. The computer program product of claim 16, wherein mapping the input image to the input feature representation comprises providing the input image as input to the trained neural network to obtain the input feature representation.

19. The computer program product of claim 15, wherein indexing the input feature representation again the data repository comprises performing a K-nearest neighbor search of the data repository using the input feature representation.

20. The computer program product of claim 15, wherein indexing the input feature representation again the data repository to identify the one or more matching pose estimations comprises:
identifying one or more feature representations stored in the data repository that match the input feature representation within a specified tolerance; and
determining that the one or more matching pose estimations are stored in associated with the one or more feature representations.
